(19) United States
(12) Patent Application Publication
(10) Pub. No.: US 2004/0202168 A1
(43) Pub. Date: Oct. 14, 2004

(54) Address assigning method, address assigning system, and networks-connecting unit

(76) Inventors: Naoki Matsuhira, Kawasaki (JP); Yukihiro Nakajima, Kawasaki (JP); Takayuki Sakuma, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/769,434

(22) Filed: Jan. 30, 2004

(30) Foreign Application Priority Data
Mar. 26, 2003 (JP) 2003-086394

(51) Int. Cl. H04L 12/28; H04L 12/56; G06F 15/16

(52) U.S. Cl. 370/393; 709/245

(57) ABSTRACT

A prefix generator that is possessed by an ISP, sets in advance a prefix that includes an SLAID which is a user setting bit string that is to be set by a user actually and stores the prefix in a card. When the user inserts the card in a router, a prefix assigning processor assigns the prefix in the card to interfaces.

### BACKGROUND OF THE INVENTION

1) Field of the Invention

The present invention relates to a method for efficiently setting a user setting bit string that is a part of the IP address by the user.

2) Description of the Related Art

A protocol called Internet Protocol version (IPv) 4 is used in the Internet. However, if the IPv 4 is used as it is, there is a lack of IP address that is necessary to identify a terminal device with which communication is to be performed and the IP address may be exhausted in the near future. Therefore, IPv 6 which is an IP address expanded to 128 bits has been drawing attention as an IP address of the next generation.

FIG. 9A illustrates detailed structure of the IP address in IPv 6. An IP address 91 in IPv 6 includes a prefix 92 that indicates to which network the IP address belongs to and an interface ID 93 that is used to identify each terminal device in a network. The prefix 92 includes 48 bits information 92a that is provided by an Internet service provider (ISP) (hereinafter, “ISP setting bit string”) and 16 bits information that is set by a user (hereinafter, “user setting bit string”) 92b.

FIG. 9B illustrates a case in which a plurality of terminal devices 97a to 97d (hereinafter, collectively called as “terminal devices 97”) are connected to the Internet via a router 94 on the user side and an Internet router or network access server 93 on the ISP side. The terminal devices 97 are connected to LANs 95 and 96. When users of the terminal devices 97 enjoy Internet connecting service provided by the ISP, an IP address 91 is allocated to each terminal device of the terminal devices 97. Moreover, from the IP address 91 allocated, the unique prefix 92 is assigned to interfaces 94a and 94b of the router 94, and the unique interface ID 93 is assigned to each terminal device of the terminal devices 97.

The network administrators (hereinafter, “users”) of the LAN 95 and the LAN 96, upon receiving the ISP setting bit string 92a from the ISP, set the user setting bit string 92b such that the prefix 92 that is unique is assigned to the interfaces 94a and 94b.

The conventional address assigning method has a problem in that it is difficult to decide what to assign as the user setting bit string 92b so that the prefix 92 becomes unique. Moreover, the process of deciding what to assign as the user setting bit string 92b exerts a great work load on the user.

In IPv 6, unlike in IPv 4, the number of bits that the user is required to set is fixed, and is as large as 16. Therefore, setting of the bits in IPv 6 is easier than in IPv 4. However, even in IPv 6, each prefix 92 has to be unique; moreover, what to assign is required to be decide. Therefore, in IPv 6, determination of the user setting bit string 92b is as complicated as in IPv 4.

Furthermore, because of the expansion of the IP address 91, household equipment like refrigerators with IPv 6 routers may appear in the market. If such household equipment appear, people such as housewives who do not know anything about an IP address may be required to set the user setting bit string.

A means and method to easily and efficiently decide the user setting bit string has been an extremely critical issue. Japanese Patent Application Laid-open Publication No. 2002-84317 discloses a method of assigning an IP address to a mobile terminal device that is moving. However, this patent publication does not disclose a method to assign IP addresses in the Internet.

### SUMMARY OF THE INVENTION

It is an object of the present invention to solve at least the problems in the conventional technology.

An address assigning method of assigning a prefix that is a part of an IP address of each interface of a networks-connecting unit that is installed between any one of a network access server and an Internet connecting router that provides an Internet connecting service to a user of each terminal device and a network to which the terminal device is connected, according to one aspect of the present invention includes creating a unique prefix that includes an ISP setting bit string that is to be set by an Internet service provider and a user setting bit string that is to be set by the user; storing the prefix created in a detachable recording medium; reading the prefix from the recording medium; and assigning the prefix read to the interface of the networks-connecting unit.

An address assigning system according to another aspect of the present invention is a method for assigning a prefix that is a part of an IP address of each interface of a networks access server and an Internet connecting router that provides the Internet connecting service to a user of each terminal device and a network to which the terminal device is connected. The networks access server includes a prefix creating unit that creates a unique prefix that includes an ISP setting bit string that is to be set by an Internet service provider and a user setting bit string that is to be set by the user; and a prefix writing unit that writes the prefix created in a detachable recording medium. The networks-connecting unit includes a reading unit that reads the prefix from the recording medium; and an assigning unit that assigns the prefix read to the interface of the networks-connecting unit.

A networks-connecting unit that is installed between any one of a network access server and an Internet connecting router that provides an Internet connecting service to a user of each terminal device and a network to which the terminal device is connected, according to still another aspect of the present invention includes a reading unit that reads data from a detachable recording medium a prefix that includes an ISP setting bit string that is to be set by an Internet service provider and a user setting bit string that is to be set by the user; and an assigning unit that assigns the prefix read to the interface of the networks-connecting unit.

The other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1 is a block diagram of a prefix setting system of an embodiment according the present invention;

FIG. 2 is an example of a global address used in the prefix setting system;

FIG. 3 is a block diagram of a prefix generator in the prefix setting system;

FIG. 4 is a flow chart of a process performed by the prefix generator;

FIG. 5 is an example of a prefix;

FIG. 6 is a block diagram of a router in the prefix setting system;

FIG. 7 is an example of contents of a routing table;

FIG. 8 is a flow chart of a process performed by the router; and

FIGS. 9A and 9B are to explain a conventional technology.

### DETAILED DESCRIPTION

Exemplary embodiments of an address assigning method, an address assigning system, and a networks-connecting unit related to the present invention are described below in detail. The embodiments are described mainly based on a case where the most basic global address in IPv 6 is used.

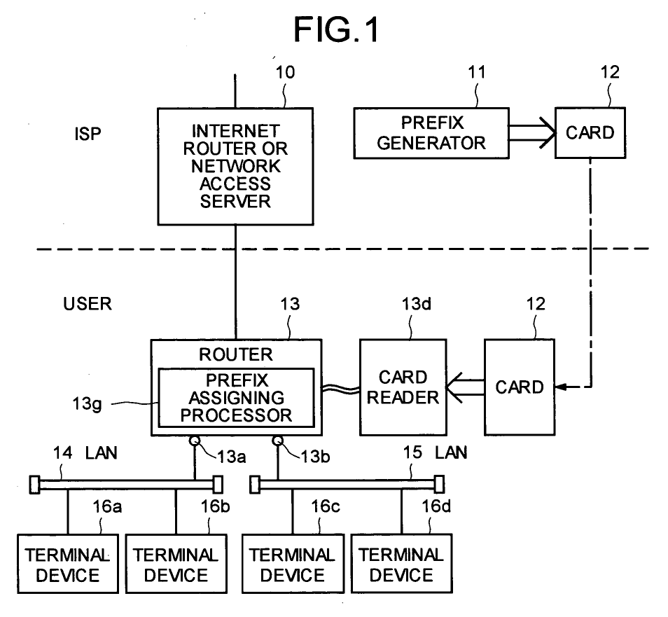

FIG. 1 is a block diagram of a prefix setting system according to an embodiment of the present embodiment. In this prefix setting system, a router 13 on the user side is connected to an Internet router or a network access server 10 on the ISP side and LANs 14 and 15 are connected to interfaces 13a and 13brespectively of the router 13. Terminal devices 16a and 16b are connected to the LAN 14 and the terminal devices 13c and 13d are connected to the LAN 15.

The Internet router or the network access server 10 is a server that upon being accessed by the terminal devices 16a to 16d performs a predetermined authentication process and then performs an Internet connecting service.

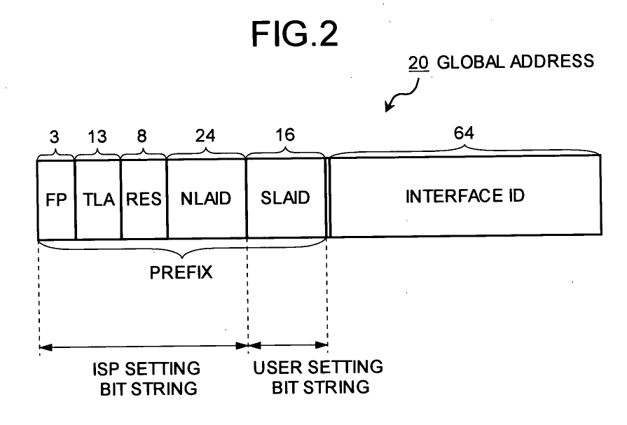

As shown in FIG. 2, a global address 20 includes a 64 bits prefix that is formed by a Format Prefix (FP), a Top-Level Aggregation (TLA), a Reserved (RES), a Next-Level Aggregation Identifier (NLAID), a Side-Level Aggregation Identifier (SLAID), and a 64 bits interface ID. The SLAID is a user setting bit string and the user sets the SLAID. A prefix generator 11 is provided on the ISP side and this prefix generator 11 generates a prefix that includes the SLAID and writes the prefix in a card 12. The card 12 is, for example, a magnetic card or an IC card that can be attached to and detached from the prefix generator 11. The prefix generated by the prefix generator 11 is assigned to the interfaces 13a and 13b.

The router 13 performs routing control of packets transmitted to the terminal devices 16a to 16d from the Internet or transmitted from the terminal devices 16a to 16d to the Internet. A card reader 13d is connected to the router 13. The card 12 can be attached to or detached from the card reader 13d. When the card 13 is attached to the card reader 13d, the card reader 13d reads the prefixes stored in the card 12 and transmits prefixes read to a prefix assigning processor 13g in the router 13. The prefix assigning processor 13g assigns prefixes to the interfaces 13a and 13b.

Thus, the prefix generator 11 on the ISP side creates the prefixes to be assigned to the interfaces of the router 13 on the user side. The prefixes created by the prefix generator 11 are supplied to the router 13 via the card 12.

These characteristics are described below concretely. To use the Internet by using IPv 6 from the terminal devices 16a to 16d, it is necessary to assign unique prefixes to the interfaces 13a and 13b of the router 13. However, if the user sets the SLAID, it is a tough task for the user unless the user has sufficient knowledge. Therefore, in the prefix setting system according to the present embodiment, the prefix setting including the setting of the SLAID is performed on the ISP side and the prefix set is set in the router 13 by using the card.

Concretely, the prefix generator 11 generates a prefix that includes the SLAID and writes the prefix generated in the card 12. When the user subscribes to the ISP, the card 12 with the prefix written therein is handed over to the user. When the user inserts the card 12 into the card reader 13d, the card reader 13d reads the prefix from the card 13, and transmits the prefix to the prefix assigning processor 13g. The prefix assigning processor 13g assigns the prefix to the interfaces 13a and 13b. Thus, the prefix can be assigned automatically just by mounting the card 12 in the card reader 13d. Therefore, almost anybody can assign the prefix.

A case in which the LAN 14 and the LAN 15 are accommodated in the router 13 and the terminal devices 16a to 16d are connected to each LAN is described here only for the sake of convenience. The present invention can also be applied to a network in which still another LAN is connected to the LAN 15 via a router and a terminal device is connected to the other LAN. In other words, the present invention is applicable even in a case where there are more than two routers.

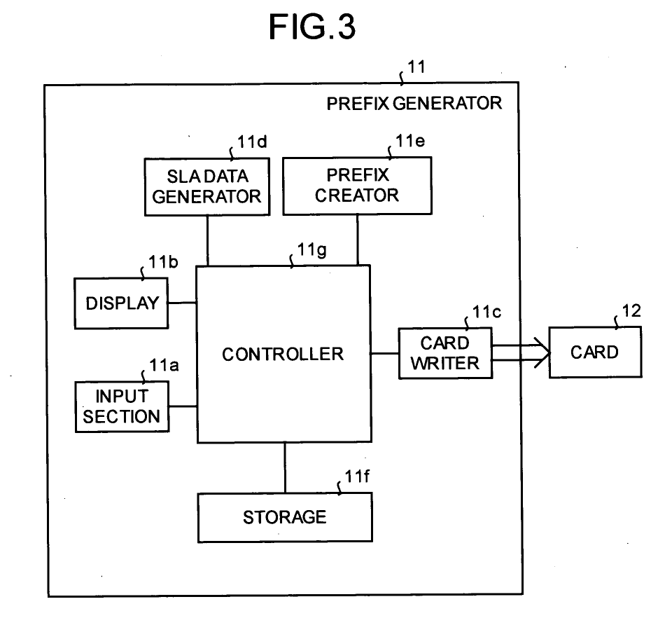

FIG. 3 is a detailed block diagram of the prefix generator 11. The prefix generator 11 includes an input section 11a, a display 11b, a card writer 11c, an SLA data generator 11d, a prefix creator 11e, a storage 11f, and a controller 11g.

The input section 11a is, for example, a key board to input a prefix other than the SLAID. Concretely, a person at the ISP side inputs the FP, the TLA, the RES, and the NLAID using the input section 11a. The display 11b is, for example, a liquid crystal display that displays input status, operation status of the input section 11a.

The card writer 11c writes the prefix generated in the card 12. Assuming that the card 12 is a magnetic card, the card writer writes the prefix in the card by magnetic recording.

The SLA data generator 11d generates a predetermined number of SLAIDs. Concretely, the SLA data generator 11d counts from 0×0000 one after the other and generates a plurality of SLAIDs. The SLAID has to be unique. On the other hand, since the SLAID has more number of bits than that in the conventional IPv 4, the precision as in IPv 4 is not sought.

The prefix creator lie generates a prefix by combining the SLAID that is generated by the SLA data generator 11d and the ISP setting bit string that is input from the input section 11a.

The storage 11f is a secondary storing (recording) medium like a hard disc. Concretely, the storage 11f stores back-up data of the prefix that is created by the prefix creator 11e.

The controller 11g controls the prefix generator 11. The control by the controller 11g includes delivering the prefix created by the prefix creator 11e to the card writer 11c, giving instructions to write the prefix in the card 12 etc.

By using the prefix generator 11, the prefix can be generated automatically and stored in the card 12. Detailed description of hardware is omitted here. A commonly used personal computer that includes a CPU, a memory, a hard-disc drive, a key-board, a CRT, a card reader etc. can be used as the prefix generator 11. Applications corresponding to SLA data generator 11d and the prefix creator 11e can be read in the CPU and executed, thereby performing the functions mentioned above.

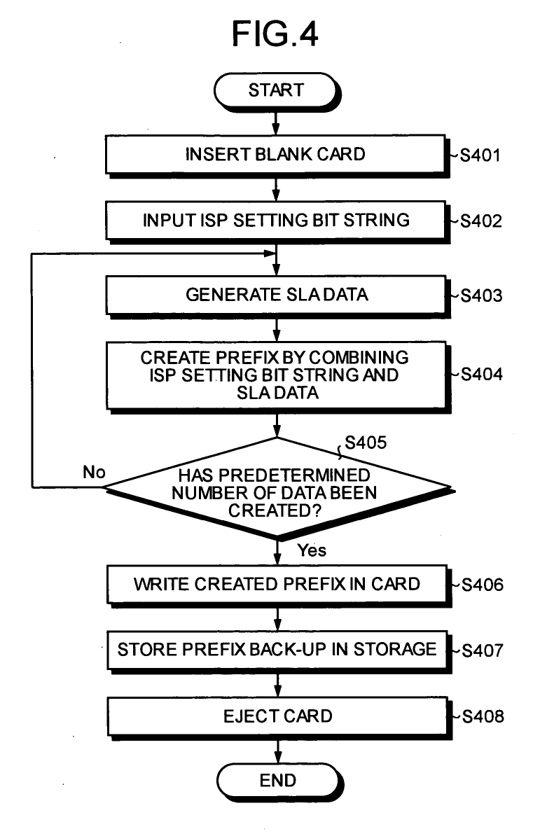

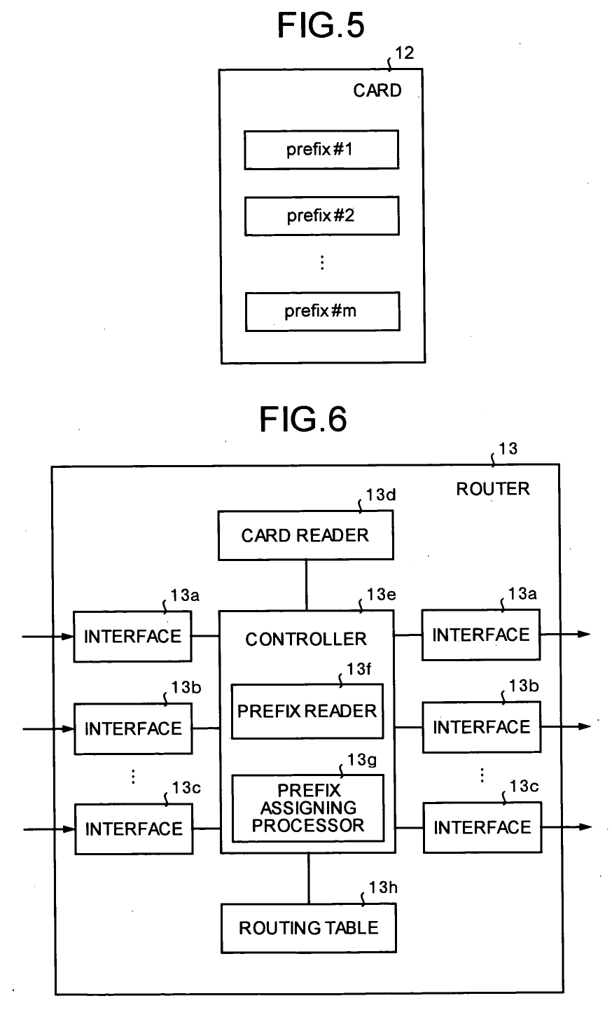

FIG. 4 is flow chart of the process performed by the prefix generator 11.

At the ISP side, the card 12 is inserted in the card writer 11 (step S401). A person at the ISP side inputs the ISP setting bit string that includes the FP, the TLA, the RES, and the NLAID from the input section 11a (step S402).

Subsequently, the SLA data generator 11d generates the SLAID (step S403), the prefix creator lie creates the prefix by combining the ISP setting bit string input and the SLAID (step S404). Further, if the number of prefixes does not reach the predetermined number (No at step S405), step S403 is executed, thereby counting the SLAID and repeating a process to create a new SLAID.

If the number of prefixes reaches the predetermined number (Yes at step S405), the card writer 11c writes each created prefix in the card 12 (step S406). After storing the back-up of the prefix in the storage 11f (step S407) the card 12 is ejected from the card writer 11c (step S408) and the process ends.

By performing the series of steps, m number of prefixes prefix#1, prefix#2, . . . , prefix#m is stored in the card 12.

FIG. 6 is a block diagram of the router 13. The router 13 includes a plurality of interfaces 13a to 13c in pairs, one each for an input and an output, the card reader 13d, a controller 13e that includes a prefix reader 13f and the prefix assigning processor 13g, and a routing table 13h.

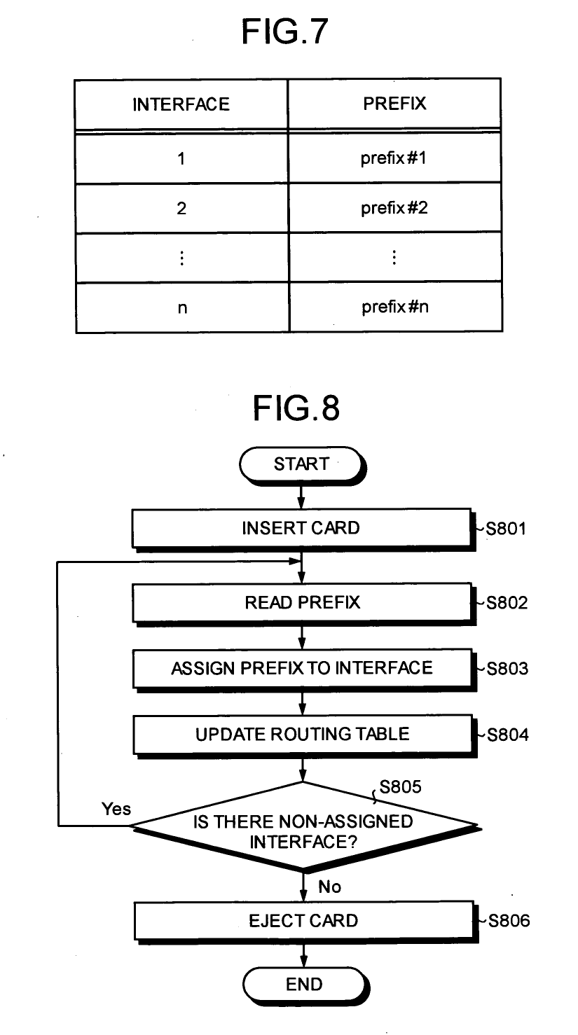

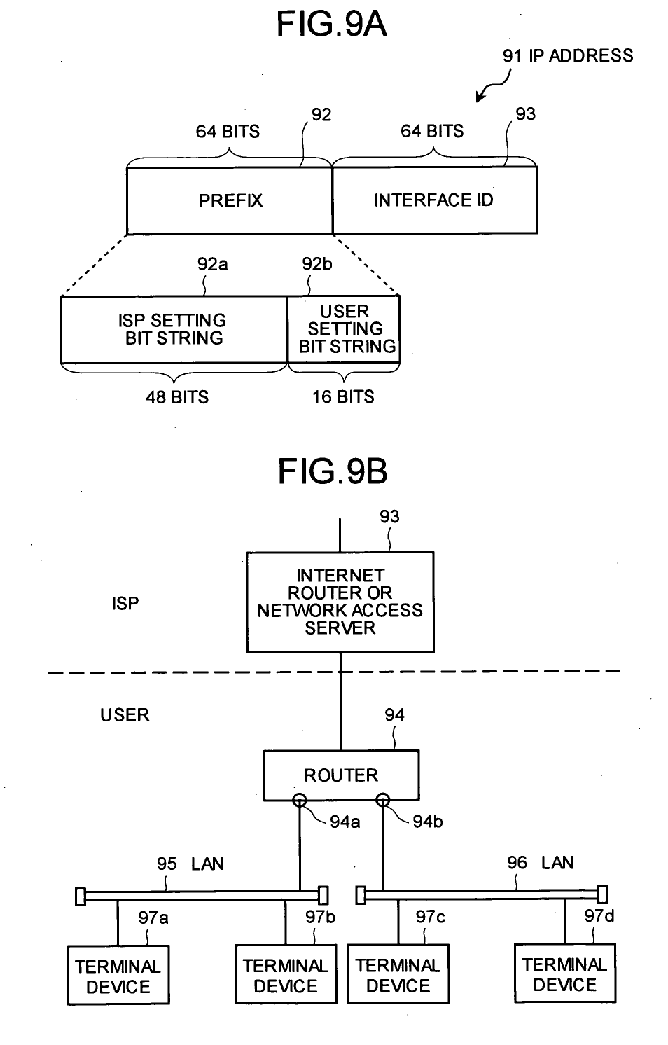

The interfaces 13a to 13c are input and output interfaces to which the Internet connecting router or the network access server 10 or the LAN 14 and the LAN 15 are connected. A prefix is assigned to each interface. Concretely, in the routing table 13h, interfaces and corresponding prefixes are stored as shown in FIG. 7. When a packet that includes a predetermined prefix in an address is received, the packet is output to an interface corresponding to the prefix.

The card reader 13d reads the prefix from the card 12 in which the prefix is stored in advance. If the card 12 is a magnetic card, the card reader reads the stored data magnetically.

The controller 13e controls the router 13 and includes the prefix reader 13f that reads prefix from the card 12 that is inserted into the card reader 13 and the prefix assigning processor 13g that assigns prefix that is read by the prefix reader 13f to the interface. Concretely, the prefix assigning processor 13g assigns the prefix by changing the relationship between the interface and the prefix in the routing table 13h.

FIG. 8 is a flow chart of a process performed by the router 13 when assigning the prefix.

When the card 12 is inserted into the card reader 13d (step S801), the prefix reader 13f reads the prefix from the card 12 (step S802). The prefix assigning processor 13g assigns the prefix to each interface (step S803). The prefix associated with each interface in the routing table 13h is updated (step S804).

The process is repeated till there is an interface to which a prefix is not assigned (Yes at Step S805). When there is no interface left without a prefix assigned to it (when prefixes are assigned to all the interfaces) (No at Step S805), the card 12 is ejected from the card reader 13d (step S806) and the process ends.

A prefix is assigned to even an interface to which LAN is not connected. Since plug-and-play is one of the characteristics of IPv 6, it is worth assigning a prefix even to an interface to which a LAN is not connected.

Thus, the prefix generator 11 sets the prefix that includes the SLAID and stores the prefix in the card 12. When the user inserts the card 12 into the card reader 13d, the prefix assigning processor 13g assigns the prefix in the card 12 to the interfaces 13a and 13b. Thus, because there is no need for the user to set the user setting bit string, it is possible to reduce the burden on the user.

Although, a case of using a global address as the IP address is described in the present embodiment, the present invention can also be applied to a case where a site local address is used. The reason being that even in the case of the site local address, there is a bit string (sub-net ID) that is to be set by the user similarly as in the global address. However, the present invention cannot be applied to a link local address in which there is no router crossing.

Although a case where IPv 6 is used is described in the present embodiment, the present invention is applicable even to other IP addresses where there is a user setting bit string.

Moreover, in the present embodiment, a case where the prefix generator 11 is used as a single unit is described. If a plurality of routers 13 are associated with the internet connecting router or the network access server 10, a means that administers prefixes that are assigned to each router 13 may be provided. The means that administrates may be included in the prefix generator 11.

In the present embodiment, a case of generating all prefixes that include the SLAID in the prefix generator is described. It is also possible to assign prefixes to the interfaces 13a and 13b of the router 13 by writing a prefix other than the SLAID in a card A, writing the SLAID in a separate card B in another unit, and inserting the cards A and B in the router 13 one after the other. In this case, the provider of the SLAID which is a user setting bit string is a third party other than the ISP and it is possible to reduce load on the ISP and set the prefix efficiently.

Furthermore, although in the present embodiment a case where one card 12 is associated with one router 13 is described, the present invention is not restricted to this case only and one card 12 can be associated commonly with a plurality of routers. However, since in this case, it is necessary to secure uniqueness of the prefix, the management has to be performed by flag etc. so that a prefix that is assigned is not used again. Due to this, a prefix can be set in the router 13 by using one card 12. As a result, it is possible to perform the operation smoothly.

Thus, according to the present invention, because a prefix is set in the networks-connecting unit by using a recording medium, the user need not set the user setting bit string and the job of the user is reduced. Particularly, the job of connecting the network includes inserting the recording medium like a card and connecting a cable only. Therefore, it is easy to introduce IPv 6 network in households and companies even in absence of a specialist of the setting job. This can contribute to spread of IPv 6 network.

Further, the prefix for the 128 bits IP address that is regulated by IPv 6 includes 48 bits ISP setting bit string and 16 bits user setting bit string that includes the SLA distinguishing information, and the networks-connecting unit is an IPv 6 router. Due to this, number of bits limit of the user setting bit string becomes less. Therefore, the prefix to be stored in the recording medium can be determined with ease.

Since a card device that is detachable from the networks-connecting unit is used as a recording medium, the prefix can be set efficiently by using the existing card device.

The Internet service provider stores the prefix in the recording medium and the user is provided with the recording medium at the time of subscription to the Internet service. This enables the reader to set the prefix easily and quickly.

A plurality of prefixes is stored in the recording medium. When the recording medium is mounted on the networks-connecting unit, the prefixes that are stored in the recording medium are assigned to each interface respectively of the networks-connecting unit. Therefore, even in a case where a large number of interfaces are used as in a high end router, the prefix can be set in each interface by using one recording medium.

When the prefix stored in the recording medium is assigned to the interface of the networks-connecting unit, the networks-connecting unit puts together and transmits the address paths. Therefore, it is possible to distribute efficiently the address paths that are required to perform the function of the networks-connecting unit like the router.

The ISP setting bit string that is to be set by the Internet service provider is stored in a first recording medium and the user setting bit string that is to be set by the user is stored in a second recording medium. When the first recording medium and the second recording medium are mounted on the networks-connecting unit, a unique prefix is generated from the ISP setting bit string and the user setting bit string. The generated unique prefix is assigned to the interface of the networks-connecting unit. Therefore, the user setting bit string is provided by a third party. This enables to reduce work load on the ISP and to set the prefix efficiently.

Among the prefixes that are stored in the recording medium, the prefix that is assigned to the interface of the networks-connecting unit cannot be used. When the recording medium is mounted on other networks-connecting equipment, the prefix that is stored in the recording medium which is not assigned is assigned to the interface of the other networks-connecting equipment. Therefore, it is possible to set the prefixes in a plurality of networks-connecting units with one recording medium. This enables to perform the operation smoothly.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An address assigning method of assigning a prefix that is a-part of an IP address of each interface of a networks-connecting unit that is installed between any one of a network access server and an Internet connecting router that provides an Internet connecting service to a user of each terminal device and a network to which the terminal device is connected, comprising:
creating a unique prefix that includes an ISP setting bit string that is to be set by an Internet service provider and a user setting bit string that is to be set by the user;
storing the prefix created in a detachable recording medium;
reading the prefix from the recording medium; and
assigning the prefix read to the interface of the networks-connecting unit.

2. The address assigning method according to claim 1, wherein the IP address is a 128 bit IP address that is regulated by Internet Protocol version 6 and the prefix includes a 48 bit ISP setting bit string and a 16 bit user setting bit string that includes SLA identification information and the networks-connecting unit is an Internet Protocol version 6 router.

3. The address assigning system according to claim 1, wherein the recording medium is a card device.

4. The address assigning method according to claim 1, wherein the creating and the storing are performed at a side of the Internet service provider.

5. The address assigning method according to claim 1, wherein the creating includes creating a plurality of prefixes and the storing includes storing the prefixes in the recording medium, the reading includes reading the prefixes from the recording medium, and the assigning includes assigning the prefixes read to respective interfaces of the networks-connecting unit.

6. The address assigning method according to claim 1, wherein the assigning includes of putting together and transmitting an address path of the networks-connecting unit when assigning the prefixes to the respective interfaces of the networks-connecting unit.

7. The address assigning method according to claim 1, wherein the storing includes storing the ISP setting bit string in a first recording medium and storing the user setting bit string in a second recording medium, the reading includes reading the ISP setting bit string from the first recording medium and reading the user setting bit string from the second recording medium, and the assigning includes combining the ISP setting bit string and the user setting bit string read to create the prefix to be assigned to the interface of the network-connecting unit.

8. The address assigning method according to claim 1, wherein the assigning includes invalidating a prefix from among the prefixes read that has been already assigned so that that prefix is not assigned again.

9. An address assigning system for assigning a prefix that is a part of an IP address of each interface of a networks access server and an Internet connecting router that provides the Internet connecting service to a user of each terminal device and a network to which the terminal device is connected, wherein
the networks access server includes
a prefix creating unit that creates a unique prefix that includes an ISP setting bit string that is to be set by an Internet service provider and a user setting bit string that is to be set by the user; and
a prefix writing unit that writes the prefix created in a detachable recording medium, and
the networks-connecting unit includes
a reading unit that reads the prefix from the recording medium; and
an assigning unit that assigns the prefix read to the interface of the networks-connecting unit.

10. The address assigning system according to claim 9, wherein the IP address is a 128 bit IP address that is regulated by Internet Protocol version 6 and the prefix includes a 48 bit ISP setting bit string and a 16 bit user setting bit string that includes SLA identification information and the networks-connecting unit is an Internet Protocol version 6 router.

11. The address assigning system according to claim 9, wherein the recording medium is a card device and the reading unit is a card reader that reads data from the card device.

12. The address assigning system according to claim 9, wherein the prefix creating unit and the prefix storing unit are installed at a side of the Internet service provider.

13. The address assigning system according to claim 9, wherein the prefix creating unit creates a plurality of prefixes and the prefix writing unit writes the prefixes in the recording medium, the reading unit reads the prefixes from the recording medium, and the assigning unit assigns the prefixes read to respective interfaces of the networks-connecting unit.

14. The address assigning system according to claim 9, wherein the assigning unit puts together and transmits an address path of the networks-connecting unit when assigning the prefixes to the respective interfaces of the networks-connecting unit.

15. The address assigning system according to claim 9, wherein the prefix writing unit writes the ISP setting bit string in a first recording medium and write the user setting bit string in a second recording medium, the reading unit reads the ISP setting bit string from the first recording medium and reads the user setting bit string from the second recording medium, and the assigning unit combines the ISP setting bit string and the user setting bit string read to create the prefix to be assigned to the interface of the network-connecting unit.

16. The address assigning system according to claim 9, wherein the assigning unit invalidates a prefix from among the prefixes read that has been already assigned so that that prefix is not assigned again.

17. A networks-connecting unit that is installed between any one of a network access server and an Internet connecting router that provides an Internet connecting service to a user of each terminal device and a network to which the terminal device is connected, comprising:
a reading unit that reads data from a detachable recording medium a prefix that includes an ISP setting bit string that is to be set by an Internet service provider and a user setting bit string that is to be set by the user; and
an assigning unit that assigns the prefix read to the interface of the networks-connecting unit.

18. The networks-connecting unit according to claim 17, wherein the IP address is a 128 bit IP address that is regulated by Internet Protocol version 6 and the prefix includes a 48 bit ISP setting bit string and a 16 bit user setting bit string that includes SLA identification information and the networks-connecting unit is an Internet Protocol version 6 router.

19. The networks-connecting unit according to claim 17, wherein the recording medium is a card device and the reading unit is a card reader that reads data from the card device.

20. The networks-connecting unit according to claim 17, wherein the Internet service provider distributes the recording medium with the prefix stored therein to the user.

21. The network connecting unit according to claim 17, wherein the reading unit reads a plurality of prefixes that are stored in the recording medium and the assigning unit assigns the prefixes read to respective interfaces of the networks-connecting unit.

22. The network connecting unit according to claim 17, wherein the assigning unit puts together and transmits an address path of the networks-connecting unit when assigning the prefixes to the respective interfaces of the networks-connecting unit.

23. The networks-connecting unit according to claim 17, wherein the reading unit reads the ISP setting bit string from a first recording medium and reads the user setting bit string from a second recording medium, and the assigning unit combines the ISP setting bit string and the user setting bit string to create the prefix and assigns the prefix to the interface of the networks-connecting unit.

24. The networks-connecting unit according to claim 17, wherein the assigning unit invalidates a prefix from among the prefixes read that has been already assigned so that that prefix is not assigned again.
